(19) United States
(12) Patent Application Publication
(10) Pub. No.: US 2019/0266821 A1
(43) Pub. Date: Aug. 29, 2019

(54) VEHICLE PASSIVE REMOTE KEYLESS ENTRY AND METHOD FOR PROVIDING A FOB ALERT

(71) Applicant: TRW AUTOMOTIVE U.S. LLC, Livonia, MI (US)

(72) Inventor: KARTHIK BALAKRISHNA, Novi, MI (US)

(21) Appl. No.: 16/281,348

(22) Filed: Feb. 21, 2019

Related U.S. Application Data
(60) Provisional application No. 62/634,973, filed on Feb. 26, 2018.

(51) Int. Cl. G07C 9/00; B60R 25/10

(52) U.S. Cl. CPC G07C 9/00309; G07C 2009/00507; G07C 2209/63; B60R 25/1001

(57) ABSTRACT

A vehicle passive remote keyless entry (PRKE) system comprises a PRKE fob and a vehicle-based PRKE controller. The vehicle-based PRKE controller is configured to control transmission and reception of PRKE signals via one or more antennas. The PRKE controller is configured to determine whether the fob is within the range of the PRKE system and also whether the fob is inside the passenger compartment of the vehicle or outside the vehicle while within the range of the PRKE system. The system is configured to provide an alert via the fob when the door is opened, the vehicle is running, and the fob is not detected in the passenger compartment of the vehicle. Further, a method for providing a fob alert in a passive remote keyless entry (PRKE) system for a vehicle is described.

### RELATED APPLICATIONS

This application claims priority from U.S. Provisional Application Ser. No. 62/634,973, filed Feb. 26, 2018, the subject matter of which is incorporated herein in its entirety.

### FIELD OF THE DISCLOSURE

Embodiments of the present disclosure generally relate to a vehicle passive remote keyless entry (PRKE) system. Further, embodiments of the present disclosure generally relate to a method for providing a fob alert in a passive remote keyless entry (PRKE) system for a vehicle.

### BACKGROUND

Vehicle passive remote keyless entry (PRKE) systems allow a driver/owner of a vehicle to enter (unlock) the vehicle, start the engine, and operate the vehicle without ever having to actively use a key or fob. PRKE systems include a fob that the owner/driver keeps on his/her person. The vehicle senses the presence of the fob and permits the holder to enter and operate the vehicle.

For obvious safety reasons, once the engine is running, the fob can leave the vicinity of the vehicle and the vehicle will remain running. This can be the case, for example, where the fob is in the possession of a passenger that is dropped off, and the vehicle drives away. This can also occur when a driver leaves the vehicle running and hands it off to another driver. It may also happen that a driver fails to switch off the engine and walks away as most of the engines are very quiet, particularly electric or hybrid vehicles.

While some systems do indicate via the instrument panel that the fob has left the vehicle, this does not affect the operation of the vehicle until the ignition is disengaged. In fact, only passengers inside the car are notified by the indication.

Furthermore, the driver/owner in a so-called relay attack scenario is completely unaware that the attack has taken place. The relay attack scenario relates to a man-in-the-middle and replay attacks, namely intercepting and manipulating communications between two parties initiated by one of the parties or initiating communication with both parties by the attacker who then merely relays messages between the two parties without manipulating them or even necessarily reading them. In fact, the relay attack occurs while the fob has left the vicinity of the vehicle.

Therefore, there is a need for a vehicle passive remote keyless entry (PRKE) system providing more security.

### SUMMARY

Embodiments of the present disclosure provide a vehicle passive remote keyless entry (PRKE) system comprising:
a PRKE fob; and
a vehicle-based PRKE controller configured to control transmission and reception of PRKE signals via one or more antennas, the PRKE controller also being configured to determine whether the fob is within the range of the PRKE system and also whether the fob is inside the passenger compartment of the vehicle or outside the vehicle while within the range of the PRKE system;

wherein the system is configured to provide an alert via the fob when the door is opened, the vehicle is running, and the fob is not detected in the passenger compartment of the vehicle.

Furthermore, embodiments of the present disclosure provide a method for providing a fob alert in a passive remote keyless entry (PRKE) system for a vehicle, comprising:
determining that the vehicle is running;
determining that a vehicle door is opened;
determining that a PRKE fob for the vehicle is not inside the passenger compartment of the vehicle; and
initiating an alert via the fob.

Accordingly, the driver/owner will be alerted if the vehicle is running and a vehicle door is opened. Thus, the driver/owner has the choice to keep the engine of the vehicle running if he wishes to. At the same time, the PRKE system alerts the driver/owner in case the driver/owner has forgotten to hand over the PRKE fob to the next driver while walking out of range of the PRKE system. Further, the driver/owner is alerted if he has forgotten to switch off the engine while walking out of range of the PRKE system. In fact, the opening of the vehicle door that is determined may relate to opening the vehicle door while leaving the vehicle. Thus, opening the vehicle door may not necessarily relate to a third person entering the vehicle, but leaving the vehicle while the vehicle engine is still running.

Generally, the PRKE system may determine that the vehicle is running and, subsequently, that a vehicle door is opened. Alternatively, the PRKE system may determine that a vehicle door is opened and, subsequently, that the vehicle is running. In any case, it is verified that the vehicle engine is running and that the vehicle door was opened. Then, it is verified whether or not the PRKE fob is within the range of the PRKE system or not.

For instance, the PRKE system may determine that the vehicle is running and the vehicle doors are closed. Subsequently, the PRKE system may determine that a vehicle door is opened.

An aspect provides that the one or more antennas comprise an interior antenna and one or more exterior antennas, and wherein the system is configured to transmit the alert to the fob via the exterior antennas. The interior antenna(s) may check whether the PRKE fob is inside the passenger compartment. The one or more exterior antennas check whether the PRKE fob is within the range of the PRKE system. Furthermore, the at least one exterior antenna is used to communicate with the PRKE fob, particularly when the PRKE fob leaves the range of the PRKE system.

According to another aspect, the system is configured to control the fob to vibrate. Hence, the PRKE system, particularly the vehicle-based PRKE controller, communicates with the PRKE fob such that the PRKE fob outputs a tactile feedback (vibration) to the owner/driver. The vehicle-based PRKE controller may transmit a respective alert control signal via at least one exterior antenna that is received by a fob antenna integrated in the PRKE fob.

The alert control signal is processed by a processor of the PRKE fob wherein the processor in turn controls a vibration motion of the PRKE fob.

Furthermore, the fob may have an integrated vibrating motor. The vibrating motor may be controlled by a processor of the PRKE fob to provide a tactile feedback in order to alert the driver/owner.

Particularly, the integrated vibrating motor is at least one of an eccentric rotating mass (ERM) motor and a printed circuit board mounted motor. The ERM motor may be an encapsulated motor that is sealed such that the vibrating motor is waterproof housed. For instance, the ERM motor may comprise a plastic housing, particularly a housing obtained by injection molding. Alternatively or additionally, the vibrating motor may be integrated in a printed circuit board (PCB) of the PRKE fob. The PCB may comprise or carry the processor that controls the integrated vibrating motor appropriately. The PCB mounted motor may be a surface mounted one. The PCB mounted motor may be a SMD vibration motor or rather a SMT vibration motor.

According to an aspect, the fob has a button configured to stop the alert when pressed. Thus, the driver/owner may acknowledge the alert by pushing the button to stop the alert. Put another way, the alert may be switched off manually by interacting with the button of the PRKE fob.

The system may comprise at least one antenna configured to transmit an alert control signal. Since the alert control signal is transmitted in case the PRKE fob is out of range of the PRKE system, the alert control signal may be transmitted by a dedicated signal having a larger range than the range of the PRKE system used for monitoring.

An aspect provides that the fob is vibrating in order to provide the alert. Hence, a tactile feedback is outputted in order to alert the owner/driver. In addition, an acoustic and/or optical alert may be outputted ensuring that the driver/owner notices the alert.

According to another aspect, an alert control signal is transmitted to initiate the alert. The alert control signal is transmitted by the vehicle-based PRKE controller vi at least one antenna, in particular an exterior antenna. The alert control signal is received by the PRKE fob, in particular via a fob antenna. The alert control signal received is processed internally by the PRKE fob in order to output the alert. Particularly, the integrated vibrating motor is controlled to vibrate such that a tactile feedback is provided.

Generally, the fob can be configured to provide an alert that is audible, tactile (vibration), or both audible and tactile when the ignition is engaged and the fob moves out of range of the passive remote keyless entry (PRKE) system of the vehicle.

The system may be configured to provide an alert via the fob when the door is opened, the vehicle is running, and the fob is also not detected within the range of the PRKE system Hence, it may be determined that the PRKE fob for the vehicle is also not detected within the range of the PRKE system, and wherein the alert is initiated via the fob when the PRKE fob is not detected in the range of the PRKE system. Thus, it is also verified whether the PRKE fob is at least in the range of the PRKE system even though the fob is outside of the vehicle compartment. Hence, a passenger holding the fob that is outside of the vehicle compartment, but close to the vehicle will not issue an alert.

The range can, for example, be a 1.5 meter radius range from the vehicle door handle. Hence, an alert will be generated if the vehicle engine is running, a vehicle door was opened and the PRKE fob is not within a 1.5 meter radius range from the vehicle door handle.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 shows a PRKE system according to the present disclosure; and

FIG. 2 shows an overview illustrating a method for providing a fob alert in a passive remote keyless entry (PRKE) system for a vehicle according to the present disclosure.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

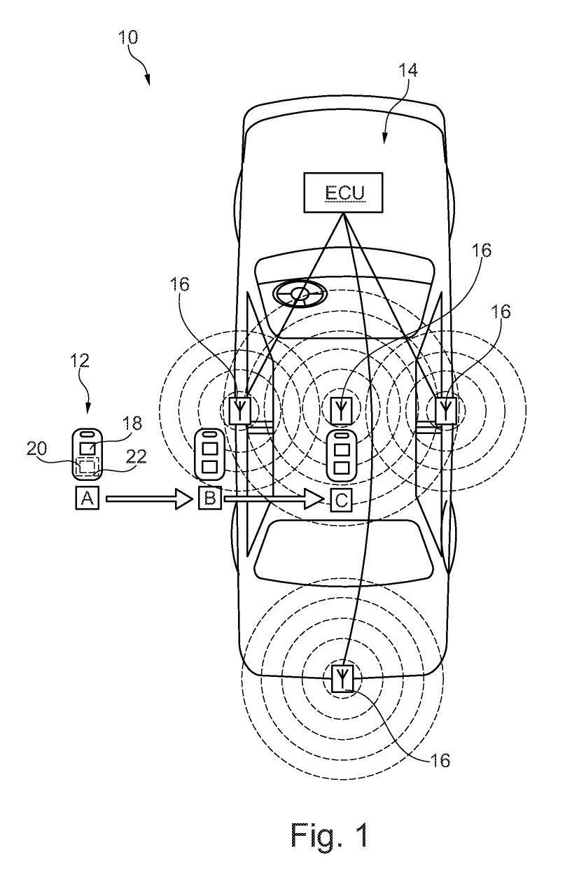

In FIG. 1, a vehicle passive remote keyless entry (PRKE) system 10 is shown that comprises a PRKE fob 12 that can be carried by the vehicle owner/operator as well as a vehicle-based PRKE controller 14 including an electronic controller unit (ECU) that controls the transmission of close range proximity signals, which is indicated generally by dashed lines. Alternatively, the vehicle-based PRKE controller 14 is established by the electronic controller unit (ECU).

The signals are transmitted via antennas 16 that are located inside and/or outside the passenger compartment wherein the antennas 16 are connected with the vehicle-based PRKE controller 14. For example, the signals can be generated via transmitters/antennas 16 mounted on a driver door, passenger door, a vehicle trunk area, and a central interior antenna.

These signals can, for example, be low frequency (LF) signals having characteristics (frequency, wavelength, amplitude) that are selected to define a PRKE range of the system 10.

Additional transmitters/antennas or fewer transmitters can be used to define the PRKE range of the vehicle.

When the fob 12, carried by the vehicle owner/operator, is outside the range of the PRKE system 10 (indicated by position A), the vehicle remains locked and the doors cannot be opened.

When the fob 12 moves from outside to inside the range of the PRKE system 10 (position B), the fob 12 receives the signal from the PRKE system 10 and transmits a corresponding response signal. The vehicle PRKE system 10, in particular the vehicle-based PRKE controller 14, receives the response, the vehicle is unlocked and the doors can be opened.

Once the fob 12 is inside the vehicle (position C), the fob 12 receives the signal from the interior transmitter/antenna and transmits a corresponding response signal indicating that it is within the range of the PRKE system 10. The vehicle can be started (ignition system actuated on/energized) and operated.

The antennas 16 of the PRKE system 10 are configured to determine whether the fob 12 is within the range of the PRKE system 10 and also whether the fob 12 is inside the passenger compartment of the vehicle (via the interior antenna) or outside the vehicle (via the exterior antennas) while within this range.

For safety reasons, once the vehicle is started, the ignition system remains energized and the vehicle can be operated even if the fob 12 leaves the range of the PRKE system 10.

This can occur, for example, if the fob 12 is in the possession of a non-driver passenger of the vehicle that leaves, e.g., is dropped off. In this event, an instrument panel warning indicator can alert the driver that the fob 12 has left the proximity of the vehicle.

The passenger possessing the fob 12, however, might not notice the alert. The remaining passenger may be stranded as the remaining passenger is unable to switch off the vehicle or to restart the vehicle later.

Furthermore, the driver may forget to switch off the vehicle engine when leaving the vehicle. This scenario becomes more realistic as modern electric or rather hybrid vehicles are silent such that the driver will not notice that the engine is still running.

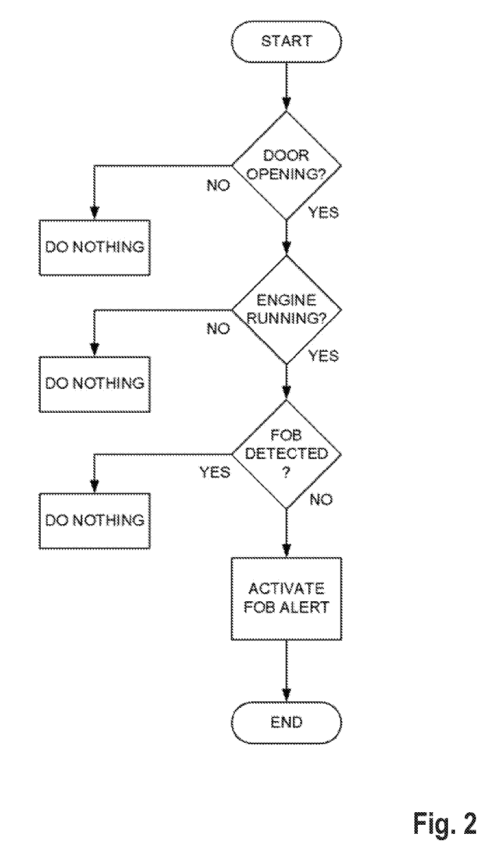

To help prevent the scenarios from occurring, the PRKE system 10 can be configured to implement a process illustrated in FIG. 2 below:

As shown in FIG. 2, the PRKE system 10 is configured to control the operation of a fob alert, such as a tactile (vibration) alert, an audible (alarm) alert, or a combination of tactile and audible alerts.

The PRKE system 10 determines whether a vehicle door has been opened. If not, the system 10 does nothing.

If the PRKE system 10 determines that a vehicle door has been opened, the PRKE system 10 determines whether the vehicle engine is running. If not, the PRKE system 10 does nothing.

If the PRKE system 10 determines that the vehicle engine is running, the PRKE system 10 determines whether the fob is detected inside the vehicle. This can be done by determining whether the PRKE fob 12 is within the range of the interior antenna.

For example, once the vehicle door open and engine running conditions are satisfied, the PRKE system 10 can transmit a fob detection signal via the interior antenna and looks for a response from the PRKE fob 12. If the PRKE system 10 detects the PRKE fob 12, the PRKE system 10 does nothing. If the PRKE system 10 does not detect the PRKE fob 12, the PRKE system 10 activates the fob alert by transmitting an alert control signal.

In this manner, the PRKE system 10 checks/determines that a door opened, the vehicle is running, and the PRKE fob 12 went undetected.

The PRKE system 10 deduces that a non-driver occupant may inadvertently have left the vehicle, taking the fob 12 with him/her and potentially stranding the driver.

The PRKE system 10 could implement further determinations, such as determining whether the driver seat or passenger seat is occupied, and determining whether the fob 12 is detected by any of the exterior transmitters/antennas, to help determine whether to activate the fob alert.

The communication of the alert can be initiated via the external transmitters/antennas, i.e., through the driver door, passenger door, and trunk mounted antennas 16.

Put another way, the PRKE system 10 is configured to provide an alert via the fob 12 when the door is opened, the vehicle is running, and the fob 12 is not detected in the range of the PRKE system 10, for instance a 1.5 meter radius range from the vehicle door handle.

Once the fob alert is initiated, it can remain active until acknowledged by pressing any of the buttons 18 on the fob 12.

Generally, the driver/owner has a choice to keep the vehicle engine on if he wishes to and at the same alerts the driver/owner in case he/she has forgotten to hand over the key to the next driver or forgot to switch off the vehicle engine

A vibrating fob alert is helpful because it can be felt by the holder, for example, in his/her pocket.

There are various types of vibration motors 20 that can be implemented in the fob 12. The vibration motor 20 can be an encapsulated vibrating motor in which the motor is sealed in a plastic housing, for instance by injecting molding techniques. For instance, the vibration motor 20 may be an eccentric rotating mass (ERM) motor. The vibration motor 20 could be mounted in the fob 12 and wired to the fob circuitry. This type of vibration motor 20 is robust to applications where durability and weatherproof operation is desired.

Vibration motors 20 can also be mounted to the fob printed circuit board (PCB) 22. These motors 20 can facilitate several connection types, including surface-mounts (SMD), through-hole chassis, or spring pad terminals. Some can even use leaded power connections and a specialized mounting technique (like adhesives) so that PCB tracks do not need to reach the motor itself.

Advantageously, the fob alert system alerts the driver/owner if the vehicle engine is running and therefor can help cut down on fuel consumption. Also, in some systems, if the owner/driver exits the vehicle with the fob 12 and leaves the engine running, the engine can be shut down only when the fob 12 returns or when the other fob kitted with vehicle is detected. The fob alert system can help overcome this inconvenience.

1. A vehicle passive remote keyless entry (PRKE) system comprising:
a PRKE fob; and
a vehicle-based PRKE controller configured to control transmission and reception of PRKE signals via one or more antennas, the PRKE controller also being configured to determine whether the fob is within the range of the PRKE system and also whether the fob is inside the passenger compartment of the vehicle or outside the vehicle while within the range of the PRKE system;
wherein the system is configured to provide an alert via the fob when the door is opened, the vehicle is running, and the fob is not detected in the passenger compartment of the vehicle.

2. The system according to claim 1, wherein the one or more antennas comprise an interior antenna and one or more exterior antennas, and wherein the system is configured to transmit the alert to the fob via the exterior antennas.

3. The system according to claim 1, wherein the system is configured to control the fob to vibrate.

4. The system according to claim 1, wherein the fob has an integrated vibrating motor.

5. The system according to claim 4, wherein the integrated vibrating motor is at least one of an eccentric rotating mass (ERM) motor and a printed circuit board mounted motor.

6. The system according to claim 1, wherein the fob has a button configured to stop the alert when pressed.

7. The system according to claim 1, wherein the system comprises at least one antenna configured to transmit an alert control signal.

8. The system according to claim 1, wherein the system is configured to provide an alert via the fob when the door is opened, the vehicle is running, and the fob is also not detected in the range of the PRKE system.

9. A method for providing a fob alert in a passive remote keyless entry (PRKE) system for a vehicle, comprising:
determining that the vehicle is running;
determining that a vehicle door is opened;
determining that a PRKE fob for the vehicle is not inside the passenger compartment of the vehicle; and
initiating an alert via the fob.

10. The method according to claim 9, wherein it is determined that the PRKE fob for the vehicle is also not detected in the range of the PRKE system, and wherein the alert is initiated via the fob when the PRKE fob is not detected in the range of the PRKE system.

11. The method according to claim 9, wherein the fob is vibrating in order to provide the alert.

12. The method according to claim 9, wherein an alert control signal is transmitted to initiate the alert.
